(19) United States
(12) Patent Application Publication
(10) Pub. No.: US 2014/0168826 A1
(43) Pub. Date: Jun. 19, 2014

(54) ACTUATING MODULE FOR AN ELECTRIC VACUUM PUMP

(71) Applicants: Alexander Kalbeck, Burglengenfeld (DE); Jürgen Schicke, Kelheim (DE); Bernd Pfaffeneder, Regensburg (DE); Michael Irsigler, Regensburg (DE)

(72) Inventors: Alexander Kalbeck, Burglengenfeld (DE); Jürgen Schicke, Kelheim (DE); Bernd Pfaffeneder, Regensburg (DE); Michael Irsigler, Regensburg (DE)

(73) Assignee: Continental Automotive GmBH, Hannover (DE)

(21) Appl. No.: 14/116,809

(22) PCT Filed: May 10, 2012
(86) PCT No.: PCT/EP2012/058685

§ 371 Date: Feb. 4, 2014

(30) Foreign Application Priority Data
May 11, 2011 (DE) 10 2011 075 684.1
Jan. 12, 2012 (DE) 10 2012 200 423.8

(51) Int. Cl. H02H 7/08

(52) U.S. Cl. CPC H02H 7/0811
USPC 361/22

(57) ABSTRACT

An electric vacuum pump actuating module for boosting the braking force of a motor vehicle, including a main controller and a driver circuit for operating the electric vacuum pump. The driver circuit includes a first and a second switch. The first switch switches a supply voltage above a predefined voltage level of an operating voltage of the vacuum pump. The second switch switches a supply voltage below the voltage level of the vacuum pump. The main controller controls the first switch by first control signals and the second switch by second control signals. The actuating module determines a state of the electric vacuum pump as a first piece of information based on a first response of the electric vacuum pump resulting from the first or second control signals. The actuating module assesses the state of the electric vacuum pump as error-free or erroneous operation of the electric vacuum pump.

### CROSS REFERENCE TO RELATED APPLICATIONS

This application is the U.S. National Stage Application of PCT International Application No. PCT/EP2012/058685, filed May 10, 2012, which claims priority to German Patent Application No. 10 2011 075 684.1, filed May 11, 2011 and German Patent Application No. 10 2012 200 423.8, filed Jan. 12, 2012, the contents of such applications being incorporated by reference herein.

### FIELD OF THE INVENTION

The invention relates to an actuating module for an electric vacuum pump for boosting brake force in a motor vehicle.

### BACKGROUND OF THE INVENTION

In the prior art, electric vacuum pumps, which are used for boosting brake force or support, are actuated by means of relays or a separate control unit (ECU). These relays or separate control units supply the electric vacuum pump with the respective onboard voltage of the motor vehicle. To date, an electric vacuum pump is switched on and off by means of one or two relays. Relays or control units to date limit their function to the operation of an electric vacuum pump.

An electric vacuum pump for a motor vehicle may—depending on the respective system design—be part of the safety-relevant systems within the context of ISO standard 26262. On the basis of this standard, a system is relevant to safety when a malfunction in the system can as a rule result in direct danger to life and limb for road users. It would therefore be relevant if the control unit controlling the electric vacuum pump could recognize a state for the operation of the electric vacuum pump and could diagnose a potential fault and/or a potential failure of the electric vacuum pump.

### SUMMARY OF THE INVENTION

An aspect of the invention provides an electric vacuum pump for boosting brake force in a motor vehicle.

An actuating module for an electric vacuum pump for boosting brake force in a motor vehicle is provided, comprising a main controller and a driver circuit for the operation of the electric vacuum pump, wherein the driver circuit comprises a first switch and a second switch, wherein the first switch is designed to connect a supply voltage above a predefined voltage level for an operating voltage of the vacuum pump, wherein the second switch is designed to connect a supply voltage below the voltage level of the vacuum pump, wherein the main controller is designed to control the first switch by means of first control signals and to control the second switch by means of second control signals, wherein the actuating module is designed to ascertain a state of the electric vacuum pump as a first piece of information on the basis of a first reaction by the electric vacuum pump that results from the first or second control signals, wherein the actuating module is designed to rate the state of the electric vacuum pump as faultless or faulty operation of the electric vacuum pump.

This can have the advantage that the functional safety of the electric vacuum pump is substantially increased. Malfunctions are recognized in real time by the actuating module. The risk that by a malfunction or a failure of the electric vacuum pump, which is a safety-relevant system within the meaning of ISO standard 26262, is significantly lowered. The capability of the actuating module of diagnosing faulty operation of the electric vacuum pump distinctly reduces the probability of occurrence of a dangerous situation that could endanger life and limb for road users.

In this case, the first switch could be in the form of a high side switch and the second switch could be in the form of a low side switch. A high side switch is a field effect transistor (FET) that connects a load to the supply voltage. A low side switch is likewise an FET and connects a load to ground.

A field effect transistor (FET) is a component that, in contrast to the bipolar transistor (bipolar junction transistor, BJT), is controlled using voltage rather than using current. A distinction is drawn between
MOSFET=metal oxide semiconductor field effect transistor; metal oxide layer FET, largest subgroup of insulated gate FETs, and
JFET=junction field effect transistor; the controllable channel is formed by a pn junction as in a diode.

The FET has three ports:
source (“inflow”),
gate,
drain (“sink”, “outflow”).

Advantages of the embodiment of the first and second switches as an FET would be:
for the most part lower losses than in the case of bipolar transistors;
very fast switching possible, therefore suitable for very high frequencies (no storage time as in the case of BJTs);
simple parallel connection in switched mode, since differences are offset by the positive temperature coefficient;
zero-power actuation in the static case, but high charge reversal losses on the gate; often cheaper than comparable bipolar transistors (BJTs);
relatively insensitive toward overvoltage between drain and source. In the event of the maximum voltage between drain and source being exceeded, what is known as “breakdown” occurs. This is comparable with the zener effect. If the amount of energy is limited, this breakdown is reversible and the FET is NOT destroyed, in contrast to the BIT.

In this case, the zener effect denotes the occurrence of a current (zener current) in the reverse direction for a highly doped semiconductor depletion layer as a result of free charge carriers.

According to one embodiment of the invention, the actuating module is designed to ascertain operating parameters for the electric vacuum pump as a second piece of information on the basis of the first reaction by the electric vacuum pump that results from the first or second control signals, wherein the operating parameters comprise:
the voltage level of the electric vacuum pump,
the magnitude of an electric current that the electric vacuum pump admits,
the temperature of the first switch, and/or
the temperature of the second switch.

This may have the advantage that the operating parameters of the electric vacuum pump are monitored continuously by the actuating module. Should the prevailing operating parameters differ from predefined setpoint values for the operating parameters, the actuating module has information to the effect that there could result a malfunction in the electric vacuum pump.

In this case, the magnitude of the respective prevailing operating parameters is ascertained by means of direct actuation of the components of the driver circuit and from the reaction thereof, so that input signals, which present the control commands to the respective component, can be aligned with output signals, which present the reaction of the respective component. A setpoint/actual comparison can therefore be used by the actuating module to constantly establish differences in the operating parameters of the components of the driver circuit and of the electric vacuum pump.

According to one embodiment of the invention, the main controller is designed to use the first information and the second information for a first evaluation and to provide a third piece of information as a result for this first evaluation, wherein the third information indicates whether operation of the electric vacuum pump is faulty, wherein the faulty operation comprises:
an overload in the driver circuit,
an overvoltage or undervoltage in the driver circuit,
a blockage in the electric vacuum pump,
a fault in the driver circuit of the actuating module and/or
an open or shorted state of a supply line to the electric vacuum pump.

This can have the advantage that the actuating module could, after initial rating of faulty states in the driver circuit, such as the presence of an overload and/or an overvoltage and/or undervoltage in the driver circuit, of a faulty mechanical state of the electric vacuum pump, of a fault in the driver circuit of the actuating module and/or an open, i.e. interrupted, or a shorted (to ground) state of a supply line to the electric vacuum pump, with the electric vacuum pump being connected to ground, and subsequent risk assessment, ascertain whether operation of the electric vacuum pump is faulty. The result of this ascertainment would then be available as a retrieval piece of information. This information for a classification of setpoint states of operating parameters for the driver circuit and/or for the electric vacuum pump as faulty operation of the electric vacuum pump could be received by other control units in the motor vehicle and processed further therein.

According to one embodiment of the invention, the main controller is also designed to receive the first and/or the second information.

This can have the advantage that the main controller could introduce first regulative countermeasures at the level of the operating parameters of the driver circuit and/or of the electric vacuum pump. By way of example, if the main controller were to receive the information that the current level prevailing in the electric vacuum pump is too high, the main controller could limit the switch-on current, for example. If the main controller were to receive the information that the electric vacuum pump is blocked, the main controller could, after assessing this as a risk, shut down the electric vacuum pump. Following an internal threat analysis and risk assessment for detecting differences in operating parameters for the driver circuit and/or for the electric vacuum pump, the main controller could therefore take first regulative measures at the level of the driver circuit and/or the electric vacuum pump in order to rectify malfunctions in the components of the driver circuit and/or of the electric vacuum pump.

According to one embodiment of the invention, the main controller is designed to initiate suitable countermeasures in the event that the third information comprises the operation of the electric vacuum pump being faulty, wherein the countermeasures comprise:
shutdown of the electric vacuum pump and/or
limitation of the magnitude of the electric current that is made available to the vacuum pump.

The actuating module therefore advantageously has the capability of regulating the driver circuit and/or the electric vacuum pump itself in the event of a malfunction occurring. This prevents the jeopardizing situation from escalating. Since the actuating module makes a piece of information about the presence of a malfunction or of a failure of the electric vacuum pump available to other control units in the motor vehicle, these control units can initiate different measures to compensate for the failure of the brake force boosting. By way of example, another control unit could initiate a hydraulically operated brake system. The risk of occurrence of a dangerous situation that is a threat to life while driving is therefore substantially reduced.

According to one embodiment of the invention, the actuating module is also designed to receive first request signals for pump activation of the electric vacuum pump and to receive second request signals for activation of the main controller.

This can have the advantage that the first request signals for the pump activation mean that setpoint signals for a setpoint activity of the electric pump are available, said setpoint activity being able to be carried out in a subsequent alignment with actual signals that reflect the actual state of the electric vacuum pump. In addition, it is advantageously ensured that the main controller is active when the electric vacuum pump is active, which means that the main controller could perform a constant monitoring function during the operation of the electric vacuum pump.

According to one embodiment of the invention, the actuating module is designed to ascertain a state of the actuating module as a fourth piece of information on the basis of a reaction by the main controller that results from the first or second request signals and/or on the basis of the first reaction by the electric vacuum pump that results from the first or second control signals.

This can have the advantage that the operation of the actuating module is itself also constantly subject to safety monitoring. The actuating module is therefore itself subject to continuous function monitoring, which ensures that a safety check on the operation of the electric vacuum pump, which can be classified as a safety-relevant system, is actually also performed. This mechanism of function monitoring for the safety monitoring allows safety requirements in ASIL (Automotive Safety Integrity Level) class C to be observed. The degree of reliability within the context of ISO standard 26262 is therefore increased.

According to one embodiment of the invention, the actuating module is designed to use the first, the second, the third and/or the fourth information for a second evaluation and to provide a fifth piece of information as a result for this second evaluation, wherein the fifth information indicates whether operation in actuation of the electric vacuum pump is faulty, wherein the first and second switches are designed to perform the actuation of the electric vacuum pump.

This has the advantage that the operation of the electric vacuum pump undergoes constant function monitoring as a result of evaluation of the interaction between actuating components and the components that execute the control commands. This in turn increases the reliability of the safety monitoring of the electric vacuum pump and at the same time limits faulty operation of the actuating module to faulty operation of the main controller.

According to one embodiment of the invention, the actuating module also comprises a safety controller, wherein the safety controller is designed to receive the fifth information, and, in the event that the result of the second evaluation was that the operation of the main controller is faulty, to deactivate the electric vacuum pump and to initiate measures for compensating for the failed electric vacuum pump, wherein the safety controller is designed to provide the deactivation of the electric vacuum pump and the initiation of the measures for compensating for the failed electric vacuum pump as a sixth piece of information for the brake force boosting.

This can have the advantage that in the event of faulty operation of the main controller an external safety controller, which performs the function monitoring for the safety monitoring of the electric vacuum pump by the main controller, this safety monitoring could be undertaken by the safety controller. Such a safety controller could therefore perform a backup functionality for the safety monitoring of the electric vacuum pump by the main controller. Even in the event of detection of faulty operation of the vacuum pump by the safety controller itself, the safety controller itself could be designed to deactivate the electric vacuum pump following a threat analysis and risk assessment and/or initiate suitable measures for compensating for failure of the electric vacuum pump in order to restore an alternative method of brake force boosting. The reliability of the safety monitoring of the safety-relevant system, the electric vacuum pump, could therefore be significantly increased. Maximum safety requirements from ASIL C could be implemented as a result.

In this context, a safety controller is a microcontroller with specific integrated hardware and software functions for monitoring and controlling another microcontroller, in this case the main controller of the actuating module for a safety-relevant system.

According to one embodiment of the invention, the main controller is designed to send the first, the second, the third, the fourth and/or the fifth information to a logic control unit in the motor vehicle, and the safety controller is designed to send the sixth information to the logic control unit in the motor vehicle.

This can have the advantage that other control units in the motor vehicle could be informed continuously about faulty operation of the safety-relevant system and/or the electric vacuum pump in redundant and hence protected fashion by means of two different logic information signals. The probability of these other control units in the motor vehicle receiving reliable information about the state of the safety-relevant system, for example the electric vacuum pump, is therefore increased. The probability of misinformation, which could result in unnecessary and perhaps even jeopardizing measures being introduced, is thereby reduced. Driving safety is therefore increased.

According to one embodiment of the invention, the actuating module and/or the safety controller are designed to send the first control signals, the second control signals, the first, the second, the third, the fourth, the fifth, the sixth information, the first and/or the second request signals in coded form as a binary signal.

This can have the advantage that there would be a high level of compatibility concerning the interfaces for transmission of information in a binary format. In a simple manner, information concerning the operating state of the electric vacuum pump, concerning the operating parameters of the electric vacuum pump, concerning a presence of faulty operation of the electric vacuum pump, concerning a state of the actuating module and/or concerning faulty operation of the main controller can be forwarded to other control units in the motor vehicle. In order to increase the breadth of variation for the information content and safety, the coding as a binary signal is not just able to be based on two values but is also able to involve the definition of a change between these two states in a variation over time as a piece of information.

Thus, by way of example, a request signal in the form of an information signal with a high frequency for a change between the level values 0 and 1 could mean that an activity by the electric vacuum pump is requested. A lower frequency for the change between the level values 0 and 1 in a request signal could, by contrast, mean that termination of the activity by the electric vacuum pump is requested. An information signal with a low frequency for a change between the level value 0 and 1 could act as an output signal indicating that the electric vacuum pump is active. The fact that the electric vacuum pump is no longer active could be indicated by an information signal with a high frequency for a change between the level values 0 and 1. For the information signals that are used to report back about the implementation of the respective request, it would therefore be possible to use respectively “converse” frequencies (high/low) for the signal change between the level values 0 and 1.

The resultant breadth of information and increased opportunity to differentiate the information signals increases the reliability of the monitoring system and increases the probability of, by way of example, detecting a short in the driver circuit, a battery failure, failure of a controller and/or other faulty operating states, for example for the electric vacuum pump. Safety when driving the motor vehicle is therefore increased.

### BRIEF DESCRIPTION OF THE DRAWINGS

The invention is best understood from the following detailed description when read in connection with the accompanying drawings. Included in the drawings if the following figures:

FIG. 1 shows a block diagram with an actuating module for controlling and monitoring an electric vacuum pump,

FIG. 2 shows a time profile for a request signal for actuating the electric vacuum pump and a time profile for an output signal from the main controller with information concerning an actual state of the electric vacuum pump and of the actuating module.

### DETAILED DESCRIPTION OF THE PREFERRED EMBODIMENTS

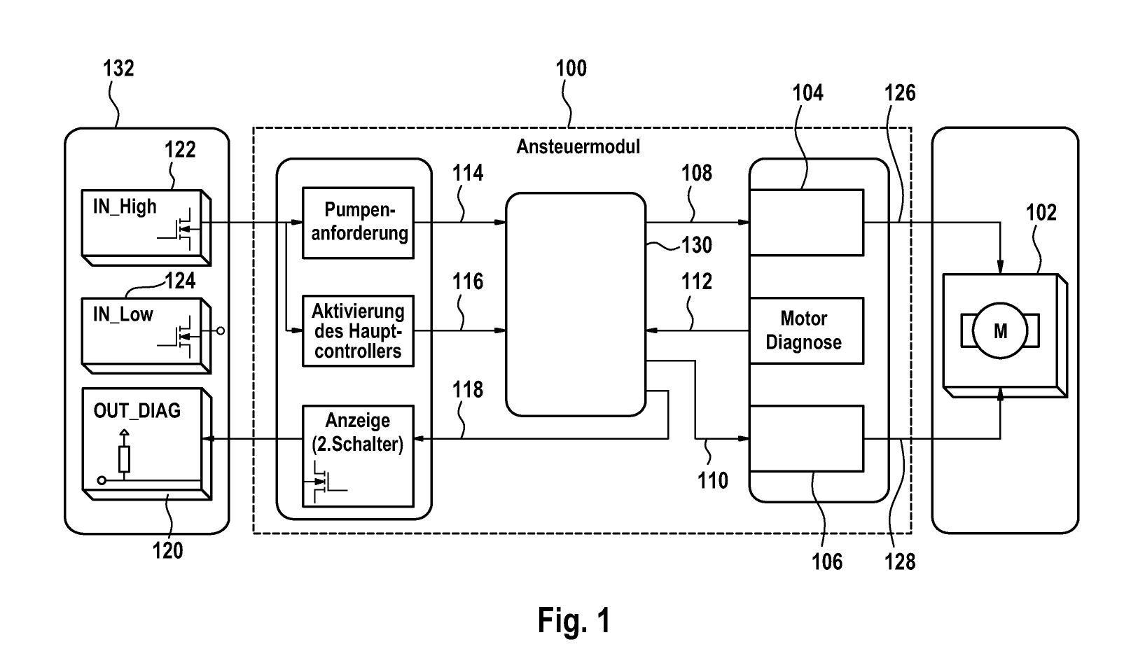

FIG. 1 shows a block diagram with an actuating module 100 for controlling and monitoring an electric vacuum pump 102 in a motor vehicle. The actuating module 100 receives first request signals 122 from a control unit 132 in the motor vehicle for the purpose of initiating a pump activity. The actuating module 100 and the main controller 130 should already be ready to receive and control in an active state as a result of a level that is kept constant for an activation signal 116. The main controller 130 then sends first control signals 108 to the first switch 104, which may be in the form of a high side switch, for example. The main controller 130 sends second control signals 110 to the second switch 106, which could be in the form of a low side switch, for example. In this case, the first switch 104 is designed to connect a supply voltage above a predefined voltage level for an operating voltage of the vacuum pump 102. The second switch 106 is designed to connect a supply voltage below the voltage level of the vacuum pump 102.

What are known as high side switches connect the positive operating voltage but can nevertheless be controlled with a ground-referenced signal.

In embodiments known in the prior art, low side switches undertake additional protection and monitoring functions. In the case of the embodiments of the invention described here, this protection and monitoring function is already undertaken by the main controller, which means that the low side switch would not need to act in a supporting role in this respect here.

The main controller 130 is designed to evaluate the reaction of the components of the driver circuit 126 and 128 in order to ascertain a state of the electric vacuum pump 102 and also of the first switch 104 and the second switch 106. Evaluation of the ascertained operating parameters and the respective states of the components of the driver circuit prompts diagnosis of whether the electric vacuum pump 102 and/or the first switch 104 or the second switch 106 is/are in a faulty operating state. This diagnosis 112 concerning the pump motor could be received and processed further by the main controller 130. By way of example, the main controller 130 could transmit a piece of information about the operating state of the second switch 106, concerning a diagnosis of whether the vacuum pump is running in a faultless or faulty fashion, and/or concerning a piece of information about whether the actuating module has faultless or faulty operation, to the external control unit 132 as a binary signal 120.

In one embodiment of the invention, the actuating module could have a low side switch and a high side switch, for example. By virtue of the output stages of these two switches being intelligently connected through and by virtue of the voltage and currents within the driver circuit being measured back at the same time, the main controller could recognize states of the electric vacuum pump 102, particularly of the motor of the vacuum pump, of the lines 126 and 128 of the driver circuit and of the actuating module. Thus, the actuating module could detect an overload in the driver circuit, an overvoltage or undervoltage in the driver circuit, a blockage in the electric vacuum pump and/or another fault in the supply lines 126 and 128 of the driver circuit, for example. Following a threat analysis and risk assessment by the main controller 130, the main controller 130 will initiate appropriate regulative measures, such as shutdown of the electric vacuum pump 102 when there is an overload in the driver circuit, when there is an overvoltage or undervoltage in the driver circuit or when it is recognized that the electric vacuum pump is blocked. If the main controller 130 were to detect a fault in the supply line system of the driver circuit 126, 128, for example, then the main controller could optionally shut down the electric vacuum pump 102 following a threat analysis and risk assessment. When an excessive current level is detected within the electric vacuum pump 102, the main controller 130 could limit the switch-on current.

As a result of standardization of the interface to the actuating module and as a result of configuration for different pumps, it would be possible to use a standard and inexpensive actuating module for all pump applications in a motor vehicle.

In the event of possible use of an additional safety controller, which is not shown in FIG. 1, the safety monitoring of the electric vacuum pump 102 by the actuating module 100 could be constantly monitored for the function of the latter. In the event of failure of the safety monitoring of the electric vacuum pump 102 by the actuating module 100, this safety controller could undertake this safety monitoring function. In the event of failure or faulty operation of the actuating module 100, it would be possible to reliably prevent the case of “continuously running pumps”, for example. Like the actuating module 100, the safety controller could similarly initiate regulative countermeasures in the event of faulty operation of the electric vacuum pump 102.

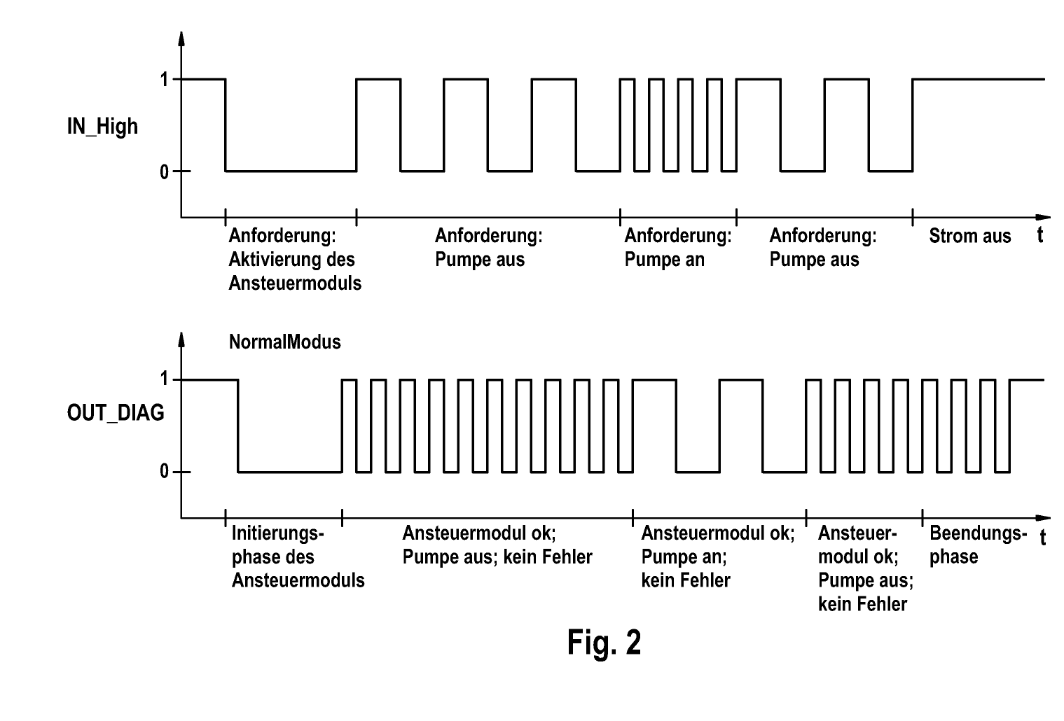

The upper region of FIG. 2 shows a time profile for request signals 132 (IN_High) for activating and deactivating the electric vacuum pump 102 given simultaneous activation of the actuating module 100.

The lower region of FIG. 2 shows a time profile for an output signal (OUT_DIAG) from the actuating module 100, with the coded binary signals and/or a coded time sequence of binary signals being a piece of information concerning:
the operating phases of the electric vacuum pump 102,
a first evaluation of whether the operation of the electric vacuum pump 102 is faultless or faulty,
a second evaluation of whether the actuating module 100 has faultless or faulty operation.

The output signals 120 (OUT_DIAG), shown in the lower region of FIG. 2, provide an external control unit of a motor vehicle with decision-relevant information regarding whether countermeasures for the failure of the electric vacuum pump, for example, may need to be initiated. At the same time, such output signals could be the basis for the conveyance of information to the vehicle driver of the motor vehicle if these output signals were to be transformed into a form of presentation that can be interpreted by the vehicle driver.

As FIG. 2 shows, a request signal (IN_High) in the form of an information signal with a high frequency for a change between the level values 0 and 1, for example, could mean that activity by the electric vacuum pump is requested (Request Pump on). A lower frequency for the change between the level signals 0 and 1 in a request signal could, by contrast, mean that termination of the activity of the electric vacuum pump is being requested (Request Pump off). An information signal with a low frequency for a change between the level values 0 and 1 could act as an output signal (OUT_DIAG) indicating that the electric vacuum pump is active (Pump on). The fact that the electric vacuum pump is no longer active could be indicated by an information signal with a high frequency for a change between the level values 0 and 1 (Pump off). For the information signals (OUT_DIAG) that are used for reporting back about the implementation of the respective request (IN-High), it would therefore be possible to use respectively “converse” frequencies (high/low) for the signal change between the level values 0 and 1.

The resultant increase in the breadth of information and created opportunity to differentiate the information signals increases the reliability of the monitoring system and increases the probability of detecting, by way of example, a short in the driver circuit, a battery failure, failure of a controller and/or other faulty operating states, for example for the electric vacuum pump. Safety when driving the motor vehicle is therefore increased.

The actuating module 100 described could therefore ensure the safety precautions—required by ISO standard 26262—for reliable safety and function monitoring for a safety-relevant system, such as the electric vacuum pump, at system level, hardware level and software level.

### LIST OF REFERENCE SYMBOLS

100 Actuating module

102 Electric vacuum pump

104 First switch

106 Second switch

108 First control line

110 Second control line

112 Line for diagnosis transmission

114 First actuation line

116 Second actuation line

118 Line for transmitting information to an external control unit

120 Output signal with diagnosis

122 Request signal

124 Request signal

126 Driver circuit

128 Driver circuit

130 Main controller

132 Control unit

1. An actuating module for an electric vacuum pump for boosting brake force in a motor vehicle, comprising a main controller and a driver circuit for the operation of the electric vacuum pump, wherein the driver circuit comprises a first switch and a second switch, wherein the first switch is designed to connect a supply voltage above a predefined voltage level for an operating voltage of the vacuum pump, wherein the second switch is designed to connect a supply voltage below the voltage level of the vacuum pump,
wherein the main controller is designed to control the first switch by first control signals and to control the second switch by second control signals, wherein the actuating module is designed to ascertain a state of the electric vacuum pump as a first piece of information on the basis of a first reaction by the electric vacuum pump that results from the first or second control signals, wherein the actuating module is designed to rate the state of the electric vacuum pump as faultless or faulty operation of the electric vacuum pump.

2. The actuating module as claimed in claim 1, wherein the actuating module is designed to ascertain operating parameters for the electric vacuum pump as a second piece of information on the basis of the first reaction by the electric vacuum pump that results from the first or second control signals, wherein the operating parameters comprise:
the voltage level of the electric vacuum pump,
the magnitude of an electric current that the electric vacuum pump admits,
the temperature of the first switch, and/or
the temperature of the second switch.

3. The actuating module as claimed in claim 2, wherein the main controller is designed to use the first information and the second information for a first evaluation and to provide a third piece of information as a result for this first evaluation, wherein the third information indicates whether operation of the electric vacuum pump is faulty, wherein the faulty operation comprises:
an overload in the driver circuit,
an overvoltage or undervoltage in the driver circuit,
a blockage in the electric vacuum pump,
a fault in the driver circuit of the actuating module and/or an open or shorted state of a supply line to the electric vacuum pump.

4. The actuating module as claimed in claim 1, wherein the main controller is also designed to receive the first information and/or the second information.

5. The actuating module as claimed in claim 3, wherein the main controller is designed to initiate suitable countermeasures in the event that the third information comprises the operation of the electric vacuum pump being faulty, wherein the countermeasures comprise:
shutdown of the electric vacuum pump and/or
limitation of the magnitude of the electric current that is made available to the vacuum pump.

6. The actuating module as claimed in claim 1, wherein the actuating module is also designed to receive first request signals for pump activation of the electric vacuum pump and to receive second request signals for activation of the main controller.

7. The actuating module as claimed in claim 6, wherein the actuating module is designed to ascertain a state of the actuating module as a fourth piece of information on the basis of a reaction by the main controller that results from the first or second request signals and/or on the basis of the first reaction by the electric vacuum pump that results from the first or second control signals.

8. The actuating module as claimed in claim 1, wherein the actuating module is designed to use the first, the second, the third and/or the fourth information for a second evaluation and to provide a fifth piece of information as a result for this second evaluation, wherein the fifth information indicates whether operation in actuation of the electric vacuum pump is faulty, wherein the first and second switches are designed to perform the actuation of the electric vacuum pump.

9. The actuating module as claimed in claim 8, wherein the actuating module also comprises a safety controller, wherein the safety controller is designed to receive the fifth information, and, in the event that the result of the second evaluation was that the operation of the main controller is faulty, to deactivate the electric vacuum pump and to initiate measures for compensating for the failed electric vacuum pump, wherein the safety controller is designed to provide the deactivation of the electric vacuum pump and the initiation of the measures for compensating for the failed electric vacuum pump as a sixth piece of information for the brake force boosting.

10. The actuating module as claimed in claim 1, wherein the main controller is designed to send the first, the second, the third, the fourth and/or the fifth information to a logic control unit in the motor vehicle, and the safety controller is designed to send the sixth information to the logic control unit in the motor vehicle.

11. The actuating module as claimed in claim 1, wherein the actuating module and/or the safety controller are designed to send the first control signals, the second control signals, the first, the second, the third, the fourth, the fifth, the sixth information, the first and/or the second request signals in coded form as a binary signal.
